(19) United States
(12) Patent Application Publication
(10) Pub. No.: US 2016/0329769 A1
(43) Pub. Date: Nov. 10, 2016

(54) INSULATION SYSTEM, STATOR, ELECTRICAL MACHINE, IN PARTICULAR A TURBOGENERATOR, AND METHOD FOR INSULATING AN ELECTRICAL CONDUCTING ELEMENT

(71) Applicant: SIEMENS AKTIENGESELLSCHAFT, Munich (DE)

(72) Inventors: Andrey Mashkin, Köln (DE); Friedhelm Pohlmann, Essen (DE); Mario Brockschmidt, Essen (DE); Alexander Litinsky, Mülheim (DE); Ralf Merte, Dortmund (DE); Guido Schmidt, Leichlingen (DE); Christian Staubach, Marl (DE)

(73) Assignee: Siemens Aktiengesellschaft, Munich (DE)

(21) Appl. No.: 15/109,668

(22) PCT Filed: Jan. 6, 2015
(86) PCT No.: PCT/EP2015/050078

§ 371 Date: Jul. 5, 2016

(30) Foreign Application Priority Data
Jan. 15, 2014 (EP) 14151235.0

(51) Int. Cl. H02K 3/34; H02K 3/40

(52) U.S. Cl. CPC H02K 3/34; H02K 3/40

(57) ABSTRACT

An insulation system of an electrical conductive element of an electrical machine, having a number of insulation system layers including an inner potential control layer, a main insulation layer, an outer corona shielding layer, and an end corona shielding layer, each of the insulation system layers having a resin-impregnated tape material strip that is wound, with a plurality of windings, around the electrical conductive element in such a way that the windings are arranged with overlapping regions half overlapping long side regions of each tape material strip, wherein, at least one of the tape material strips is flattened at the long side regions thereof, in relation to the mid-region thereof.

### CROSS REFERENCE TO RELATED APPLICATIONS

This application is the US National Stage of International Application No. PCT/EP2015/050078 filed Jan. 6, 2015, and claims the benefit thereof. The International Application claims the benefit of European Application No. EP14151235 filed Jan. 15, 2014. All of the applications are incorporated by reference herein in their entirety.

### FIELD OF INVENTION

The invention relates to an insulation system of an electrical conducting element of an electrical machine with a number of insulation system layers comprising an inner potential control layer, a main insulation layer, an outer corona shielding layer and an overhang corona shielding layer, in which these insulation system layers respectively comprise a resin-impregnated tape material strip, which is wound with a multiplicity of windings around the electrical conducting element in such a way that the windings are arranged with overlapping regions half-overlapping at long side regions of the respective tape material strip.

The invention also relates to a stator of an electrical machine with at least one laminated stator core comprising slots and with electrically conducting conducting elements, which are arranged in an insulating manner in the slots of the at least one laminated stator core.

The invention further relates to an electrical machine, in particular a turbogenerator, with an insulation system for insulating electrical conducting elements in relation to a laminated stator core for securing the electrical conducting elements.

The invention additionally relates to a method for insulating an electrical conducting element of an electrical machine, in which an inner potential control layer, a main insulation layer, an outer corona shielding layer and an overhang corona shielding layer are respectively wound as tape material strips with a multiplicity of windings around the electrical conducting element and in which these windings are arranged half-overlapping at long side regions of the respective tape material strip.

### BACKGROUND OF INVENTION

In particular, insulation systems of the type in question are well known from the prior art. By means of such insulation systems, electrically conducting conducting elements, such as for instance generator winding bars of copper, on rotating electrical machines of the type in question, such as for example turbogenerators, but in some cases also in water generators or other motors, are insulated. These electrical conducting elements are secured in an insulated manner in a main body of a stator of an electrical machine and thereby substantially form the actual stator winding. For this purpose, the main body generally comprises a grounded laminated core, which provides a multiplicity of slots, in which the electrical conducting elements are fixed. During operation, extremely high potentials in the double-digit kilovolt range are present at such a stator winding. The electrically conducting conducting elements must therefore be insulated in relation to this laminated core with a correspondingly formed insulation system. For this purpose, the insulation system comprises a main insulation with a main insulation layer comprising one or more tape material strips, which are wound in a number of layers around the respective electrical conducting element. In addition, the insulation system also comprises a potential control layer, arranged further inward, and an outer corona shielding layer, arranged further outward, and an overhang corona shielding layer, likewise arranged further outward. The inner potential control layer, the outer corona shielding layer and the overhang corona shielding layer also consist of tape material strips wound around the electrical conducting element. The potential control layer lying on the inside and the outer corona shielding layer lying on the outside serve for shielding from voids and detachments. Taken from the inner potential control layer in the radial direction to the outer corona shielding layer, the electrical voltage is reduced in the main insulation layer, whereby it is ensured that the electrical field only remains inside the main insulation layer and no partial discharges occur between the main insulation layer and the grounded laminated core. For the axial control of the electrical field at the axial ends of the outer corona shielding layer, the less conductive overhang corona shielding layer is applied, this layer being electrically connected to the outer corona shielding layer. As already mentioned, generally all of the aforementioned insulation system layers are produced layer by layer from tape material strips, which are respectively wound, primarily half-overlapping, around the electrical conducting element and are impregnated with resin. The half-overlapping arrangement mentioned of the individual windings of the respective tape material strip on the one hand ensures a good axial and radial connection of the windings in the conductive layers and longest-possible erosion paths in the main insulation layer. This allows a very long service life to be ensured. The tape material strips of the main insulation layer in this case contain mica particles with an insulating effect, while the tape material strips of the other layers are doped with various semiconductive and/or conductive particles. An insulation system made up in such a way has proven to be very successful, but it is disadvantageous that defective areas that are predominantly filled only with resin and less with the mica particles with an insulating effect occur in the main insulation layer in the overlapping regions. These defective areas of the main insulation layer that are formed in this way differ from the other areas of the main insulation layer, in which there is a proper resin/mica particle mixture, by having a lower dielectric strength. However, on account of the lower permittivity in comparison with the proper resin/mica particle mixture, the defective areas undergo greater field loading. For this reason, such defective areas should be avoided as far as possible.

### SUMMARY OF INVENTION

An object of the invention is to further develop insulation systems of the type in question in order at least to overcome the aforementioned disadvantages.

An object of the invention is achieved by an insulation system of an electrical conducting element of an electrical machine with a number of insulation system layers comprising an inner potential control layer, a main insulation layer, an outer corona shielding layer and an overhang corona shielding layer, in which these insulation system layers respectively comprise a resin-impregnated tape material strip, which is wound with a multiplicity of windings around the electrical conducting element in such a way that the windings are arranged with overlapping regions half-overlapping at long side regions of the respective tape material strip, wherein the insulation system is distinguished according to the invention by the fact that at least one of the tape material strips is flattened at its long side regions in relation to its middle region.

These flattened long side regions succeed in a surprisingly easy way in avoiding an inter-spatial volume of a critical size between the windings, whereby in turn the risk of the occurrence of large interspaces that are predominantly only filled with resin, and scarcely contain any mica particles, is reduced. This applies especially to the main insulation layer of the present insulation system.

With regard to the other more conductive insulation system layers, there is additionally the advantage that sharp-edged stepped portions, which may in particular protrude radially beyond the windings and into the main insulation layer, can be avoided, whereby the risk of local increases in the electrical field is significantly reduced there. Such increases in the electrical field may be particularly marked at the inner potential control layer and at the outer corona shielding layer.

Furthermore, in these regions too, the occurrence of resin-filled interspaces can be prevented, or at least restricted, so that the risk of partial electrical discharges that can be caused by a mixture of field distortions, electrically conductive edges and a weak electrical conductivity of the resin can be reduced well.

By means of the insulation system according to the invention, it is advantageously possible overall to counteract very well the risk in particular of erosion induced by partial discharges occurring in insulation systems that are electrically loaded, accompanied by the formation of “treeing” channels, which can ultimately lead to the electrical breakdown of the insulation.

It goes without saying that all of the insulation system layers may be provided with a tape material strip that has flattened side regions in relation to its middle region.

The present insulation system may advantageously be used between electrical conducting elements and a ground potential in the region of the slots and winding overhangs of an electrical machine.

To this extent, an object of the invention is also achieved by a stator of an electrical machine with at least one laminated stator core comprising slots and with electrically conducting conducting elements, which are arranged in an insulating manner in the slots of the at least one laminated stator core, the stator being distinguished by an insulation system on the basis of one of the present features. This allows the stator to be made more efficient and/or to have a longer service life.

Similarly, an object of the invention is achieved by an electrical machine, in particular a turbogenerator, with an insulation system for insulating electrical conducting elements in relation to a laminated core for securing the electrical conducting elements, the electrical machine being distinguished by an insulation system on the basis of one of the present features and/or by a stator on the basis of one of the present features. This allows the operational reliability of the electrical machine to be increased significantly.

The insulation system according to the invention has the individual insulation system layers, specifically the inner potential control layer (IPS), the main insulation layer, the outer corona shielding layer (AGS) and the overhang corona shielding layer (IPS).

In the insulation system, taken from a center axis of the electrical conducting element to be insulated, the inner potential control layer is wound radially inward in certain regions directly onto the electrical conducting element. Arranged radially further outward is the main insulation layer, which in turn is wound onto the radially further inward-lying inner potential control layer. Following radially still further outward are the outer corona shielding layer and the overhang corona shielding layer, which are wound axially next to one another onto the radially further inward-lying main insulation layer.

It goes without saying that each of the insulation system layers can be produced by one or more such tape material strips. For example, a number of tape material strips are wound onto one another in the radial direction as winding layers, in order for example to obtain a sufficiently thick main insulation layer.

Even a design according to the invention that comprises only one of the insulation system layers can generally already contribute to a significantly longer service life of the insulation system.

In connection with electrical machines, the term “electrical conducting element” describes wires, coils, bars or the like that are prominently electrically insulated in relation to one another and/or in relation to a laminated stator core and/or the other surroundings of the electrical machine.

It also goes without saying that the tape material strips can be variously produced with their long side regions flattened in relation to the middle region or with their flat side ends.

The present tape material strips may for example be produced in the previously customary way, from tapes rolled up onto large rolls. These tapes are cut to size application-specifically to form the respective tape material strip with the desired width. For production reasons, the tapes have in this case a rectangular profile, whereby the tape material strips cut out from them also likewise have a correspondingly rectangular profile. In the present case, this rectangular profile is however re-formed as required by the invention if the tape material strips used here are produced from such tapes.

It should be clarified at this point that the production of the present tape material strips is not restricted to this method of production.

The respective tape material strip therefore advantageously has flat side ends at its long side regions.

This is accomplished particularly easily if the material of the tape material strip is compressed at the long side regions or at the outer sides of the tape material strip.

To this extent, an object of the invention is also achieved by a method for insulating an electrical conducting element of an electrical machine in which an inner potential control layer, a main insulation layer, an outer corona shielding layer and an overhang corona shielding layer are respectively wound as tape material strips with a multiplicity of windings around the electrical conducting element and in which these windings are arranged half-overlapping at long side regions of the respective tape material strip, wherein the long side regions of at least one of the tape material strips wound around the electrical conducting element is compressed before the winding and/or during the winding around the electrical conducting element.

Such compressing or pressing of the long side regions may be performed for example in the production process of the tape material strips or during the cutting to size of the tape material strips from a wide continuous tape.

In any event, the present insulation system can be produced particularly easily by such compressing or pressing of the tape material strips.

If at least one of the tape material strips is made to be thinner in the widthwise direction at its long side regions than in the region of its longitudinal center axis, the volume of the interspaces between individual windings can be greatly reduced, especially in the overlapping regions.

It is also advantageous in this connection if the tape material strip has a smaller material thickness at its outer sides than in its middle region, in order in this way to be able to obtain favorable overlapping regions at the individual insulation system layers.

While tape material strips have until now had a constant tape material strength or tape material thickness throughout, in particular in the widthwise direction, it is advantageous in the present case if at least one of the tape material strips has a variable tape cross section in the widthwise direction. As a result, the cross section of the tape material strip in the widthwise direction is not homogeneously formed, so that the effects explained above can be realized well. This is so because the conventional tape material strips have a rectangular profile for production reasons.

The interaction between individual windings can be further improved if at the long side regions the upper surface side of the tape material strip and the lower surface side of the tape material strip converge into the side borders to a point.

A further advantageous configurational variant provides that at least one of the tape material strips is biconvexly shaped in the widthwise direction with regard to its two surface sides. Biconvexly shaped surface sides allow the tape material strip to be shaped in an arcuate or more rounded manner than previously possible, in particular at its long side regions, so that the individual windings can lie more closely against one another in the overlapping regions, whereby in turn interspaces between the individual winding layers are much less pronounced.

Tape edges or side borders rounded in this way can be advantageously produced, whereby sharp edges at the tape sides or side borders of the long side regions can be avoided.

Furthermore, it is advantageous if a middle region of at least one of the tape material strips goes over by means of a continuously curved transitional region into long side regions of this one tape material strip that are made thinner than the middle region. The continuously curved transitional region allows the long side regions of the tape material strip that interact with one another to lie closely against one another in a particularly gap-free manner at the windings lying against one another or one on top of the other.

Expediently, an outer side border of a long side region of one winding of the at least one tape material strip is arranged beyond a point of inflection of a widthwise concavely curved surface of a directly neighboring winding of the at least one tape material strip, so that the windings of the at least one tape material strip can be connected particularly intimately to one another.

The individual windings of the tape material strip can additionally interact much better with one another if an outer side border of a long side region of one winding of the tape material strip is arranged beyond the longitudinal center line of a directly neighboring winding of the tape material strip. Also in this way, the risk of partial discharges can be reduced.

Furthermore, it is advantageous if a contact area between two directly neighboring windings of the at least one tape material strip is arranged in the widthwise direction beyond a point of inflection of a widthwise concavely curved surface of a directly neighboring winding of the at least one tape material strip.

At least the contact area is not reduced in comparison with previous solutions and remains at least equally large. Such a contact area allows the risk of partial discharges to be further reduced in particular.

It should be mentioned once again at this point that the favorable effects described at the beginning with regard to an electrical field are advantageously obtained by the more favorably formed interspaces with their smaller resin volumes, and the consequently altogether more homogeneous design of the insulation system according to the invention, especially at the overlapping regions. The smaller interspaces have the effect of only allowing the occurrence of much smaller defective locations in which areas of resin with a smaller proportion of mica particles can collect, whereby altogether the electrically stable, inorganic proportion in the insulation system is greater. This in turn increases the dielectric strength in particular. The present features have the effect that the thermal conductivity of the insulation system tends to be higher. Moreover, the resin consumption during the production of the insulation system falls.

Furthermore, with respect to the boundary region between the outer corona shielding layer and the main insulation layer and with respect to the boundary region between the inner potential control layer and the main insulation layer, the rounded tape material strip edges also have the effect that local field increases at the side borders can ideally be avoided entirely.

Apart from the already described avoidance of field increases, further major effects and advantages that can be achieved with the present invention, individually or in combination, are for example also a reduced rate of erosion of the main insulation layer, reduced or ideally eliminated erosion of the more conductive insulation system layers, in particular the outer corona shielding layer, an insulation system of a generally thinner construction with the same service life requirements or expectations and/or an increase in performance of the electrical machine or in particular of the turbogenerator.

In general, the present features of the invention, in particular the rounded or biconvex form of the tape material strips, allow a more homogeneous design of the insulation system to be realized, with the consequence of reduced field distortions in the main insulation layer and with the avoidance of conductive edges or the like at the more conductive insulation system layers, such as for instance the inner potential control layer, the outer corona shielding layer and the overhang corona shielding layer.

A detail of an embodiment of the insulation system according to the invention of an electrical conducting element of a turbogenerator that is secured in an insulated manner in a laminated stator core is explained below on the basis of the accompanying schematic drawings.

### BRIEF DESCRIPTION OF THE DRAWINGS

In the drawings:

FIG. 1 shows a schematic plan view of an insulation system of an electrical conducting element held in an insulated manner in a slot of a laminated stator core of a turbogenerator, and

FIG. 2 shows a schematic view of a detail of a main insulation layer and of an inner potential control layer adjacent thereto and lying radially further inward of the insulation system from FIG. 1.

### DETAILED DESCRIPTION OF INVENTION

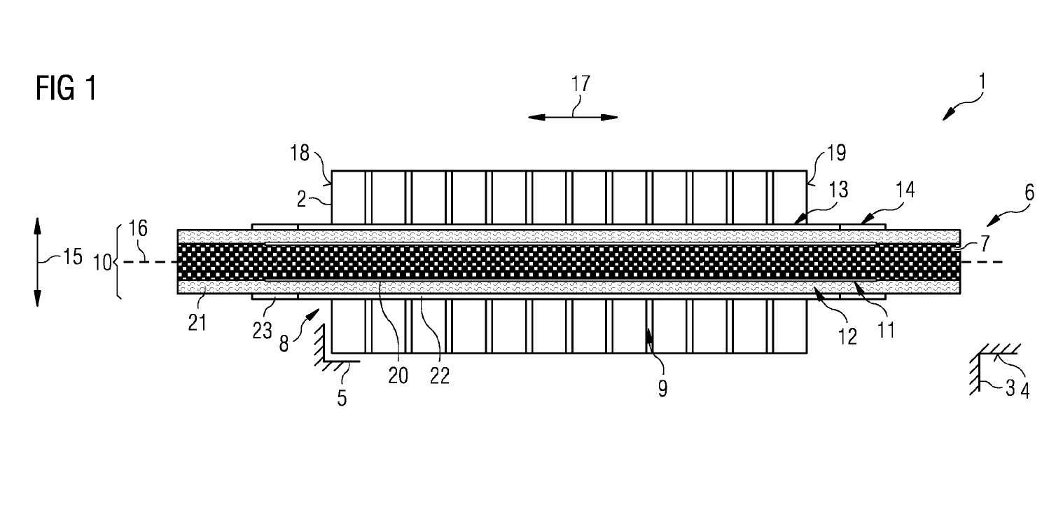

The insulation system 1 according to the invention is provided on a laminated stator core 2, shown by way of example in FIG. 1, of a stator 5 used on an electrical machine 3 in the form of a turbogenerator 4, in order to insulate an electrical conducting element 6 in the form of a copper bar element 7 in relation to the laminated stator core 2. The electrical conducting element 6 is arranged here in slots 8 (only shown by way of example) of the laminated stator core 2. The laminated stator core 2 is also passed through by a multiplicity of cooling channels 9, in order to be better able to dissipate heat.

The insulation system 1 consists of a multiplicity of insulation system layers 10, specifically an inner potential control layer 11, a main insulation layer 12, an outer corona shielding layer 13 and an overhang corona shielding layer 14, which are wound around the electrical conducting element 6.

In this exemplary embodiment, the insulation system layers 10 are arranged as follows in the radial direction 15.

Taken from a center axis 16 of the electrical conducting element 6 to be insulated, the inner potential control layer 11 is wound radially further inward in the axial direction 17 in certain regions directly onto the electrical conducting element 6, so that the inner potential control layer 11 projects beyond the end sides 18 and 19 of the laminated stator core 2. In this exemplary embodiment, the inner potential control layer 11 is configured as an inner tape material strip 20 which is impregnated with resin (not numerically denoted) and wound around the electrical conducting element 6.

Arranged radially further outward is the main insulation layer 12, which turn is wound onto the radially further inward-lying inner potential control layer 11. In this exemplary embodiment, the main insulation layer 12 is accordingly configured as middle tape material strips 21 (only numerically denoted by way of example) that are impregnated with resin (not numerically denoted), which are wound around the inner potential control layer 11.

Arranged radially still further outward are then the corona shielding layer 13 and the overhang corona shielding layer 14, which in the axial direction 17 are wound axially next to one another onto the radially further inward-lying main insulation layer 12. Both the outer corona shielding layer 13 and the overhang corona shielding layer 14 are respectively produced as outer tape material strips 22 and 23 that are impregnated with resin (not numerically denoted).

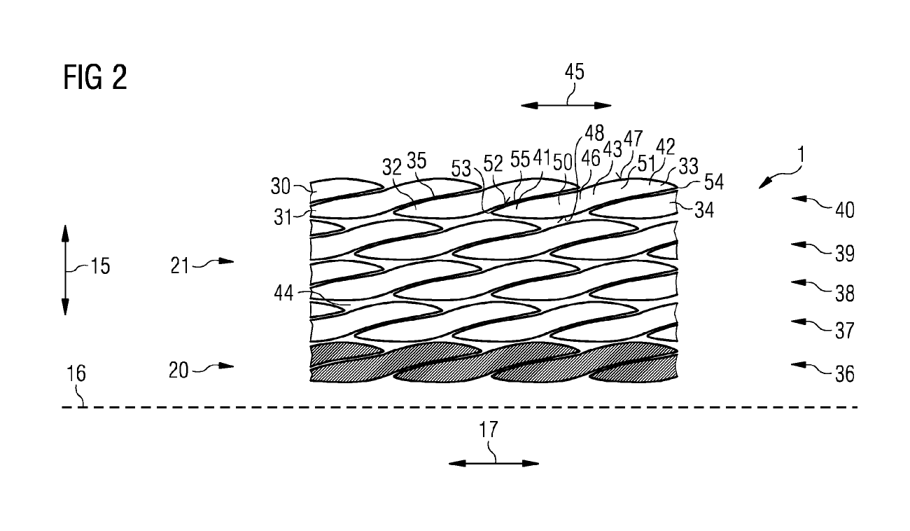

As can be seen from the representation according to FIG. 2, for producing the individual insulation system layers 10 the respective tape material strips 20, 21, 22 and 23 are respectively wound with a multiplicity of windings 30, 31, 32, 33, 34 (only numerically denoted by way of example, see FIG. 2) around the electrical conducting element 6; to be precise in such a way that the individual windings 30, 31, 32, 33, 34 of the respective tape material strip 20, 21, 22 and 23 are arranged half-overlapping one another in the axial direction 17 along the center axis 16 with overlapping regions 35 (only numerically denoted here by way of example).

In this exemplary embodiment, the inner potential control layer 11 consists of an individual winding layer 36 produced by the individual tape material strip 20, while the main insulation layer 12 is wound from a total of four winding layers 37, 38, 39 and 40.

As explained by way of example with reference to the winding 33 as representative of all the other windings 30, 31, 32 and 34 of the insulation system layers 10, in this exemplary embodiment the tape material strips 20 to 23 are flattened at their respective long side regions 41 and 42 in relation to their respective middle regions 43. This allows the windings 30, 31, 32, 33 and 34 to lie closely against one another, and as a result much smaller resin-filled interspaces 44 (only numerically denoted by way of example) occur than has previously been the case with methods known from the prior art.

In any event, the previously known problems with regard to defective locations that are primarily filled only with resin, and a consequently lower dielectric strength, etc., are solved well in the present case.

This flattening of the long side regions 41 and 42 can be achieved particularly well by the tape material strips 20 to 23 cut to the final width size or produced directly in the final width size being compressed at their outer sides or at the long side regions 41 and 42.

It is undoubtedly favorable that the tape material strips 20 to 23 are made thinner in their widthwise direction 45 at their long side regions 41 and 42 than in the region of their longitudinal center axes 46 (only numerically denoted here by way of example), and consequently have a variable tape cross section.

In addition, the individual windings 30, 31, 32, 33 and 34 lie even closer together here, since the surface sides 47 and 48 of the respective tape material strips 20 to 23 are respectively biconvexly curved continuously, and not angled in the previously customary way.

Furthermore, continuously curved transitional regions 50 and 51 (only depicted here by way of example) lie between the middle regions 43 of the tape material strips 20 to 23 and the flattened thinner long side regions 41 and 42, whereby the individual windings 30 to 34 lie even closer against one another.

Furthermore, the contact areas 52 (only numerically denoted here by way of example) acting between the individual windings 30 to 34 are particularly pronounced in terms of being of a large area, since the outer side borders 53 and 54 (only numerically denoted by way of example) of the long side regions 41 and 42 of the windings 30 to 34 are arranged beyond a respective point of inflection 55 (only numerically denoted by way of example) of the widthwise 45 concavely curved surface sides 47 and 48 of the respectively directly neighboring windings 30 to 34.

Although the invention has been more specifically illustrated and described in detail by the exemplary embodiment, the invention is not restricted to this disclosed exemplary embodiment and other variations can be derived herefrom by a person skilled in the art without departing from the scope of protection of the invention.

1. An insulation system of an electrical conducting element of an electrical machine comprising:
a number of insulation system layers comprising an inner potential control layer, a main insulation layer, an outer corona shielding layer and an overhang corona shielding layer,
in which these insulation system layers respectively comprise a resin-impregnated tape material strip, which is wound with a multiplicity of windings, around the electrical conducting element in such a way that the windings, are arranged with overlapping regions half-overlapping at long side regions of the respective tape material strip,
wherein at least one of the tape material strips is flattened at its long side regions in relation to its middle region,
wherein at least one of the tape material strips is thinner in the widthwise direction at its long side regions than in the region of its longitudinal center line.

2. The insulation system as claimed in claim 1,
wherein at least one of the tape material strips has a variable tape cross section in the widthwise direction.

3. The insulation system as claimed in claim 1,
wherein at the long side regions the upper surface side of the tape material strip and the lower surface side of the tape material strip converge into the side borders to a point.

4. The insulation system as claimed in claim 1,
wherein at least one of the tape material strips is biconvexly shaped in the widthwise direction with regard to its two surface sides.

5. The insulation system as claimed in claim 1,
wherein a middle region of at least one of the tape material strips goes over by means of continuously curved transitional regions into long side regions of this one tape material strip that are made thinner than the middle region.

6. The insulation system as claimed in claim 1,
wherein an outer side border of a long side region of one winding of at least one of the tape material strips is arranged beyond a point of inflection of a widthwise concavely curved surface of a directly neighboring winding of this one tape material strip.

7. The insulation system as claimed in claim 1,
wherein an outer side border of a long side region of one winding of at least one of the tape material strips is arranged beyond the longitudinal center line of a directly neighboring winding of this one tape material strip.

8. The insulation system as claimed in claim 1,
wherein a contact area between two directly neighboring windings, of at least one of the tape material strips is arranged in the widthwise direction beyond a point of inflection of a widthwise concavely curved surface of a directly neighboring winding of this one tape material strip.

9. A stator of an electrical machine with at least one laminated stator core comprising slots and with electrically conducting conducting elements, which are arranged in an insulating manner in the slots of the at least one laminated stator core,
wherein the stator comprises an insulation system as claimed in claim 1.

10. An electrical machine, comprising:
an insulation system for insulating electrical conducting elements in relation to a laminated stator core for securing the electrical conducting elements,
wherein the electrical machine is distinguished by comprises
an insulation system as claimed in claim 1 and/or
a stator with at least one laminated stator core comprising slots and with electrically conducting elements, which are arranged in an insulating manner in the slots of the at least one laminated stator core comprising an insulation system as claimed in claim 1.

11. A method for insulating an electrical conducting element of an electrical machine, the method comprising:
respectively winding an inner potential control layer, a main insulation layer, an outer corona shielding layer and an overhang corona shielding layer as tape material strips with a multiplicity of windings around the electrical conducting element and in which these windings are arranged half-overlapping at long side regions of the respective tape material strip,
compressing the long side regions of at least one of the tape material strips wound around the electrical conducting element before the winding and/or during the winding around the electrical conducting element.

12. The electrical machine of claim 10,
wherein the electrical machine comprises a turbogenerator.
